(19) United States
(12) Patent Application Publication
(10) Pub. No.: US 2023/0283035 A1
(43) Pub. Date: Sep. 7, 2023

(54) CASCADING RAMAN AMPLIFIER WITH OVERLAPPING RESONATORS

(71) Applicant: Applied Energetics, Inc., Tucson, AZ (US)

(72) Inventors: Alan Kost, Tucson, AZ (US); Stephen William McCahon, Tucson, AZ (US); Gregory J. Quarles, Tucson, AZ (US)

(73) Assignee: Applied Energetics, Inc., Tucson, AZ (US)

(21) Appl. No.: 18/174,220

(22) Filed: Feb. 24, 2023

Related U.S. Application Data
(60) Provisional application No. 63/268,445, filed on Feb. 24, 2022.

(51) Int. Cl. H01S 3/082; H01S 3/10; H01S 3/30; H01S 3/08

(52) U.S. Cl. CPC H01S 3/082; H01S 3/08095; H01S 3/10092; H01S 3/30

(57) ABSTRACT

The invention includes a device for amplifying light having a pumping resonator and a Raman resonator that share an output mirror and are divided by an interior mirror. A pumping beam is directed though a gain medium in each resonator. A seed signal is directed into the Raman resonator, which is configured to contain cascaded Raman-shifted signals generated through the interaction of the pumping beam, seed signal, and gain medium, and to transmit a selected Raman-shifted signal as optical output. Also disclosed is a method of amplifying light using a Raman resonator that partially overlaps a pump resonator. A pumping beam is directed through a pump gain medium and a Raman gain medium and generates cascading Raman-shifted signals within the Raman resonator. A seed signal is used to shape the temporal profile, and improve the coherence, of the Raman-shifted signals.

### CROSS-REFERENCE TO RELATED APPLICATIONS

This application claims priority to U.S. Provisional Application No. 63/268,445, filed Feb. 24, 2022, and has specification that builds upon U.S. Application No. 17/655,484, filed Mar. 18, 2022, each of which is hereby incorporated by reference herein in its entirety.

### BACKGROUND OF THE INVENTION

### Field of the Invention

Embodiments of the present invention relate to light amplification and more particularly to amplification of light using a seeded Raman amplifier configured with overlapping resonators.

### Relevant Background

A laser, or Light Amplification by Stimulated Emission of Radiation, is a device that generates highly energetic and coherent beams of light that can be focused into a narrow directional beam. At its most basic level, a laser includes a gain medium in an optical cavity. The cavity being typically defined by a pair of mirrors at either end that reflect light within the cavity. An energy source for pumping energy into the gain medium in the form of electromagnetic radiation completes the basic component list.

The gain medium is a set of atoms, molecules, or ions in gaseous, solid, or liquid state that acts to amplify laser light through stimulated emission. The medium exists in a state of inversion, in which the number of atoms with electrons in an excited level outnumber the atoms with lower energy electrons.

An optical or an electric pump is often used to create the necessary inversion within the gain medium to power a laser. A gain medium absorbs the energy from the pump, transforming a portion of the atom population from their ground state to a higher energy state. Photons are emitted from the gain medium, and are amplified by stimulated emission into a beam of laser light. A material continuously exposed to pump energy forms a continuous laser while a pulsed laser is formed using a periodic pump.

One known class of amplifying pumps are known as regenerative amplifiers. In such an amplifier, light passes multiple times through a single gain medium, or plural gain media, to efficiently extract a gain. In a regenerative amplifier, an optical path is defined in which an input pulse or signal makes several passes through the gain medium before being directed out as an amplified signal. Laser pulses with ultrashort pulse durations in the picosecond or femtosecond ranges can be created using this technique. Multiple passes through the gain medium, such as a solid-state medium, are achieved by placing the gain medium in an optical cavity or resonator, together with an optical switch that may be formed by an electro-optic modulator. The number of round trips in the resonator can be controlled with the optical switch, and when this number is large, a high overall amplification of the laser can be achieved.

Laser light can also be amplified by Raman amplification, which can produce a coherent, laser-like output by transfer of power from a laser pumping beam to a longer wavelength output signal. Raman amplification is the transfer of energy from a pumping beam to a Raman-shifted or Stokes signal in the form of absorbed photons. The gain medium absorbs photons from the pumping beam, which are then immediately re-emitted as lower-frequency laser-light photons with high vibrational energy (“Stokes” photons) by a process called stimulated Raman scattering. The difference between the frequency (or wavelength) of the pumping beam and the wavelength of the emitted Stokes photons is fixed and corresponds to a vibrational frequency of the gain medium.

Seeded Raman amplification is accomplished by directing both a laser pumping beam and a seed signal into a Raman gain medium. A seeded Raman amplifier can be used to convert a relatively low brightness optical pumping beam into high-brightness output signal. Further, using a pumping beam and a seed signal together makes it possible to produce arbitrary laser-output wavelengths by choosing the pumping beam and seed signal wavelengths appropriately.

However, in existing devices for seeded Raman amplification, the Raman gain medium is located outside the resonator for the pumping beam. The pumping beam makes multiple passes through its gain medium within the resonator before exiting and making a single pass through the Raman gain medium where it interacts with the seed signal to produce a Raman laser output. In such configurations, seeded Raman amplifiers suffer from low pumping beam power and incomplete transfer of power to the Raman laser, leaving residual power in the pumping beam that remains unused. The result is an inefficient and low power Raman laser.

Previous efforts to improve seeded Raman amplification are disclosed in U.S. Application No. 17/655,484, “Raman Amplifier with Shared Resonator,” filed Mar. 18, 2022 (“484”) and incorporated herein by reference. In 484, a Raman gain medium is located within a shared optical cavity with the pumping laser gain medium. The shared resonator configuration improves the resulting laser by improving the efficiency of energy transfer from the laser pumping beam to the seed signal.

The disclosed invention improves on the seeded Raman amplification devices and methods disclosed in 484 by altering the Raman resonator to allow cascading Stokes amplification of the seed signal and the introduction of multiple seed signals. One advantage thereby gained is that the wavelength and temporal profile of the Raman laser output can be tuned by introducing a seed signal of appropriate wavelength and temporal profile. The disclosed invention also allows for the production of a brighter (higher quality) laser output. Brightness, or radiance, as used herein is a measure of the optical power per unit area and solid angle of divergence of the output. High brightness beams travel farther with less spreading and can deliver more power/energy to a smaller area. As disclosed, the current invention is also suitable for implementation in optical fiber.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures imbedded in the text below and attached following this description.

FIG. 1 depicts a high-level system diagram of an optical amplifier with Stokes amplification according to an embodiment of the disclosed invention;

FIGS. 2A-2C depict a high-level system diagram of at least a portion of an optical amplifier with Stokes amplification according to an embodiment of the disclosed invention; and

FIG. 3 depicts a high-level system diagram of an optical amplifier with Stokes amplification according to an embodiment of the disclosed invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Disclosed herein are devices and methods for producing laser light using a shared resonator cavity for a pumping beam and a Raman signal wherein the Raman signal resonator is configured to create a cascading Raman-shifted signal. The disclosed invention more efficiently transfers energy from a laser pumping beam to a separate seeded Raman-shifted signal having a substantially longer wavelength and higher vibrational energy. The pumping beam circulates in one of two or more resonators, passing bi-directionally through a first gain medium where its power is continually replenished. Seeded Raman-shifted signals circulate in a second resonator that partially overlaps the first resonator and contains a Raman gain medium. As the seeded Raman-shifted signals circulate within the second resonator, they absorb energy from the pumping beam and cascade through a succession of Raman-shifted signals, each having a progressively longer wavelength. The power from the pumping beam is thus transferred efficiently and accumulates in a final, high power/energy, long wavelength Raman-shifted signal which is the output of the system.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature’s relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

### Overlapping Raman Resonators

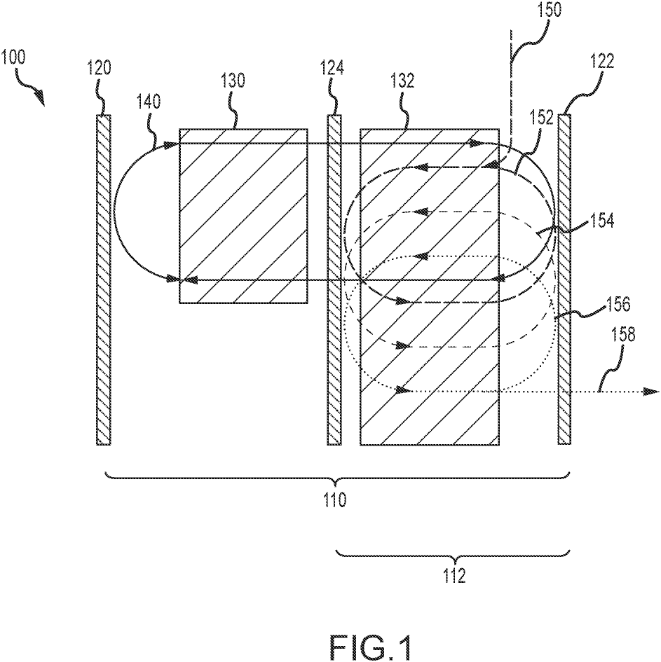

With reference to FIG. 1, a high-level schematic diagram of an embodiment 100 of the disclosed invention is depicted. The laser 100 includes two overlapping resonators, a pump resonator 110 and a Raman resonator 112. The pump resonator 110 is contained between two outer mirrors 120, 122 and includes a pump gain medium 130. The first outer mirror 120, and the second outer mirror (or output mirror) 122 are configured to be highly reflective of a pumping beam 140 and retain it within the pump resonator. The pump gain medium 130 is configured to impart energy to the pumping beam 140 and replenish it to high power as it passes back and forth through the medium in both directions of travel. The pump gain medium may be any medium that provides optical gain for the pumping beam, and is maintained in an inversion state by an energy source (not shown). The high optical power pumping beam 140 more efficiently transfers energy to Stokes signals produced in the Raman resonator 112.

The Raman resonator 112 is contained within the output mirror 122 and an inner mirror 124, and includes a Raman gain medium 132 and a seed signal 150. The Raman resonator 112 overlaps the pump resonator 110 over a portion of the pump resonator’s length. The output mirror 122, in addition to being highly reflective of the pumping beam 140, is also configured to be highly reflective of Stokes signals below a certain wavelength 152, 154, but has a level of transmittance for longer wavelength Stokes signals 156 that are the output 158 of the laser 100. Alternatively, the output mirror 122 can be switched between a state that is highly reflective of the output signal and a state that is transmissive of the output signal. The inner mirror 124 is configured to have high transmittance for the pumping beam 140, but is highly reflective of all Stokes signals generated in the Raman resonator 112. The seed signal 150 is tuned to the wavelength of the first Stokes signal 152, and is pumped into the Raman gain medium 132 to interact with the medium and the pumping beam 140. The Raman gain medium 132 is configured to produce and transfer energy to the Stokes signals 152, 154, 156 as they circulate through the material in both directions. The Raman gain medium is maintained in an inversion state by an energy source (not shown). The Raman gain medium can be comprised of any material that exhibits stimulated Raman scattering at the desired optical wavelengths.

In operation, the pumping beam 140 circulates in the pump resonator 110 and in the Raman resonator 112 so that the pumping beam travels in both directions through both gain media 130, 132. Such a configuration allows bi-directional pumping beam regeneration and bi-directional Raman scattering, both of which improve the overall efficiency of the laser 100. Within the Raman resonator, the pumping beam generates and amplifies Stokes signals through interaction with the Raman gain medium 132. Energy from the pumping beam is transferred to the first Stokes signal 152 as atoms within the Raman gain medium absorb pumping beam photons, and then immediately re-emit them through stimulated Raman scattering. Stokes signals circling within the Raman resonator 112 have a longer wavelength than the pumping beam and differ from the pumping beam frequency by multiples of Δω_{R}, a quantity that specifies the Raman shift in signal wavelength, which is fixed and corresponds to a vibrational frequency of the Raman gain medium 132. For example, if the pumping beam has frequency ωₚ, the first Stokes signal 152 will have frequency of ωₚ-Δω_{R}, the second 154 will have frequency of ωₚ-2Δω_{R}, and so on until the final Stokes signal 156 has frequency of ωₚ-nΔω_{R}, where n is the number of different Stokes signals produced (in this depiction n=3). Pumping beam frequency is selected in conjunction with the Raman gain medium to produce output signals in the required range of wavelengths. As the pumping beam 140 passes through the Raman gain medium 132 in both directions, its power is efficiently transferred to the Stokes signals. The disclosed configuration achieves increased power transfer efficiency through the extended period of overlap between the pumping beam and Stokes signals within the Raman resonator. The power transferred out of the pumping beam is replenished as the beam circulates through the pump medium 130.

The Raman resonator 112 is configured to produce and amplify an output Stokes signal 158 through a cascading process. Initially, the pumping beam 140 generates and amplifies a first Stokes signal 152. In this embodiment, a seed signal 150 tuned to the wavelength of the first Stokes signal is pumped into the Raman gain medium 132 to shape the first Stokes signal’s temporal profile. As the first Stokes signal circulates within the Raman gain medium 132, it absorbs additional energy from the pumping beam and is amplified. As it circulates, the first Stokes signal 152 also interacts with the Raman gain medium to generate and amplify longer wavelength Stokes signals 154, 156. Over the course of laser operation, power concentrates in the longer wavelength Stokes signals as they become increasingly amplified.

The output mirror 122 is configured to be partially or selectively transmissive of the nth signal 156, which is transmitted out of the Raman resonator as output 158. While the output signal is depicted here as the third Stokes signal, the invention is not so limited, and the output mirror can be configured to transmit any of the cascaded Stokes signals, as required by the application. One advantage of the disclosed invention is the ability to select among a broad range of wavelengths for the output signal which may otherwise be difficult or impossible to produce. Output signal wavelength may be selected based on various criteria, for example, the ability of the signal to travel through certain media without attenuation.

The output signal wavelength is selected and controlled by the reflectance and transmission characteristics of the output mirror 122 with respect to the generated Stokes signals. The mechanism of promoting transmission of the output signal by the output mirror may vary based on the temporal profile of the output signal 150. For a continuous wave (CW) or a long-pulse output signal, the output mirror may be partially transmissive of the output signal wavelength. Such partial transmittance allows the signal to amplify within the Raman resonator while a certain amount of the signal passes through the mirror as output. The transmittance of the output mirror for the output wavelength in such cases may vary, and may depend on, for example, the amount of amplification of the Stokes signal provided by the Raman gain medium. For a short-pulse output signal, the output mirror 122 may be configured to have selective transmissibility to the output wavelength. In such cases, the output mirror is set to be highly reflective of the output wavelength while the nth Stokes signal becomes amplified. Once the nth Stokes signal is sufficiently amplified, the output mirror is switched to be highly transmissive of the output wavelength, allowing the output signal to pass out of the resonator 112.

The seed signal 150 is used to control the temporal profile and enhance the quality of Stokes signals within the Raman resonator. The seed signal may be configured to interact with the pumping beam 140 and Raman gain medium 132 to generate CW, long-pulse (e.g., nanoseconds, microseconds, or milliseconds), or short-pulse (e.g., picoseconds or femtoseconds) optical outputs 158. As used herein, long-pulse signals will have a spatial profile that is longer than the length of the Raman resonator (depicted in the figures as the left to right direction), while short-pulse signals will have a spatial profile that is shorter than the length of the Raman resonator. Various combinations of seed signal temporal profiles and pumping beam temporal profiles (CW, long-pulse, or short-pulse) are possible and contemplated to produce the highest quality output with a specified temporal profile. The output signal will have a temporal profile set by the seed signal temporal profile regardless of the temporal profile of the pumping beam.

The temporal profile of the pumping beam 140 is selected based at least in part on the quality of available lasers for the required frequency. For example, if the frequency of the pumping beam is selected to produce an output signal with a specified range of wavelengths, such lasers may not be available as long-pulse lasers, and therefore a CW laser must be used. For another application requiring a pumping beam of a different frequency, a long-pulse laser is available and would produce a superior output signal, so the long-pulse pumping beam is selected. Pumping beams may be short-pulse lasers, however, some Raman gain media may not be responsive enough to produce quality seeded Stokes signals with short-pulse pumps. Further, if a short-pulse pumping beam is used with a short-pulse seed signal, the signals must be timed so that their spatial profiles coincide to arrive simultaneously at the same location within the Raman gain medium. Once the pumping beam profile is selected, the seed signal is selected to generate the output signal of the specified temporal profile.

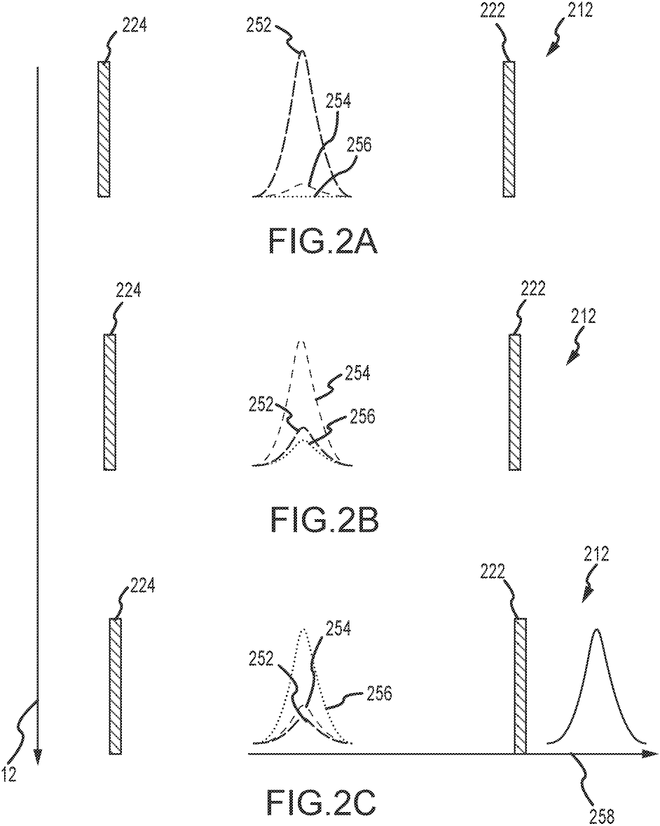

With reference to FIGS. 2A, 2B, and 2C, the process of power accumulation in the Raman resonator is depicted. Time in the depicted figures advances according to the arrow 12. FIG. 2A depicts the relative amplitudes of Stokes signals shortly after initiating laser operation, i.e., when the Stokes signals have made only a small number of round trips between the inner mirror 224 and the output mirror 222 of the Raman resonator 212. Just after laser start-up, the first Stokes signal 252 has the greatest amplitude, because the pumping beam (not shown) primarily generates and amplifies the first Stokes signal. As the first Stokes signal 252 circulates within the Raman resonator 212 and interacts with the Raman gain medium (not shown), the first Stokes signal generates and amplifies the second Stokes signal 254, which in turn generates and amplifies the third Stokes signal 256. At this early stage of the process, Stokes signals further down the cascade of signals 254, 256 have begun to form, but have lower amplitudes because relatively less power has accumulated in those signals. With reference to FIG. 2B, an intermediate stage of laser operation is depicted in which the passage of time has allowed the second Stokes signal 254 to exceed the amplitude of the first Stokes signal 252 as power accumulates at that wavelength. The third Stokes signal 256 increases in amplitude as the power accumulated in the second Stokes signal generates and amplifies more signals at that wavelength. Finally, FIG. 2C depicts an advanced stage of laser operation in which power has accumulated in the third Stokes signal 256 so that its amplitude now exceeds the amplitudes of earlier shorter wavelength signals 252, 254. A portion of the third Stokes signal 256 passes through the output mirror 222 as laser output 258. Although FIGS. 2A-2C illustrate power accumulation in the third Stokes signal, the reflectance of the output mirror can be selected to promote power accumulation in any longer wavelength nth Stokes signal having frequency ωₚ-nΔω_{R}.

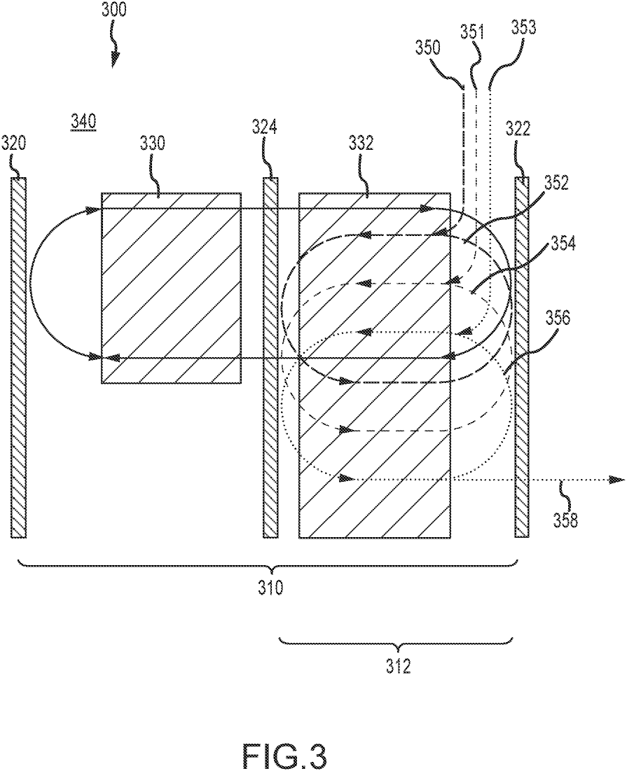

With reference to FIG. 3, another embodiment of the disclosed invention including multiple seed signals is depicted. In this embodiment, the laser 300 is configured to include seed signal pumps for pumping a plurality of seed signals 350, 351, 353 into the Raman resonator 312. As shown, there are three seed signals, each of which corresponds to a Stokes signal generated within the Raman resonator. A first seed signal 350 is tuned to the frequency of the first Stokes signal 352, a second seed signal 351 is tuned to the frequency of the second Stokes signal 354, and a third seed signal 353 is tuned to the frequency of the third Stokes signal 356. While three seed signals and Stokes signals are shown, embodiments of the disclosed invention may include many cascaded Stokes signals with corresponding seed signals. In some embodiments, not every Stokes signal has a corresponding seed signal, for example, only the first Stokes signal and nth Stokes signal may have a corresponding seed signal. Further, various combinations of CW, long-pulse, and short-pulse pumping beam and seed signals may be used. Multiple configurations of seed signal pumps and laser outputs are possible and contemplated.

Use of multiple seed signals provides several benefits, including improvement of output signal quality and accelerated formation of cascaded longer wavelength Stokes signals. For example, in embodiments using a single seed signal, the generation and amplification of longer wavelength Stokes signals is relatively slow as those signals emerge from the background of first Stokes signal amplification. However, the use of additional seed signals tuned to the wavelength of one or more cascaded Stokes signals accelerates the transfer of power from the pumping beam to those additional seeded Stokes signals. Similarly, the growth of cascaded Stokes signals out of noisy background signals tends to produce noisy Stokes signals, where a noisy signal is one with a randomly varying phase. However, because seed signals are coherent with a well-defined phase, they tend to promote the formation of coherent Stokes signals and hence more coherent output signals.

Embodiments of the disclosed invention provide advantageous features enhancing efficiency, control, and quality of laser output. For example, the shared resonator configuration improves efficiency by allowing the pumping beam to travel bi-directionally through both gain media, and allows the Stokes signals to travel and cascade bi-directionally through the gain medium. Such efficiency gains can be used to reduce the power required to generate the desired optical output beams. The shared resonator also improves control by allowing a given pumping beam to generate Stokes signal outputs over a wide range of wavelengths. Further control over the spectral and temporal profile of the output is also enhanced by use of a pumping beam with one or more seed signals. As configured, a CW or long-pulse pumping beam can efficiently transfer energy to a short-pulse Stokes signal having pulse widths in the picosecond or femtosecond range. Finally, the quality of output is improved by transfer of power from the pumping beam to a longer wavelength Raman-shifted pulse. The disclosed invention can convert low energy and low brightness pumping beams into outputs with high brightness, and high powers or energies, e.g., on the milli-Joule or multiple Joule scales.

While there have been described above the principles of the present invention in conjunction with Raman amplification with an overlapping resonator configuration, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate claims to such features and/or combinations of such features during the prosecution of the present application or of any further application derived therefrom.

What is claimed is:

1. A device for amplifying light, comprising:
a pumping beam;
a first resonator, including an outer mirror, an output mirror, and a pump gain medium, wherein the outer mirror and the output mirror are reflective of the pumping beam;
a first seed signal;
a second resonator, including the output mirror, an input mirror located between the output mirror and the outer mirror, and a Raman gain medium,
wherein the inner mirror is reflective of one or more cascaded Stokes signals, and is transmissive of the pumping beam,
wherein the output mirror is reflective of the one or more cascaded Stokes signals, and is one of the following: partially transmissive of an output Stokes signal, or selectively transmissive of the output Stokes signal.

2. The device for amplifying light of claim 1, further comprising a plurality of seed signals.

3. The device for amplifying light of claim 1, wherein the pumping beam is one of the following: a continuous wave light source, a long-pulse light source, or a short-pulse light source.

4. The device for amplifying light of claim 1, wherein the first seed signal is one of the following: a continuous wave light source, a long-pulse light source, or a short-pulse light source.

5. The device for amplifying light of claim 1, wherein the pumping beam passes through the pump gain medium and the Raman gain medium in at least two directions.

6. A device for amplifying Raman-shifted light, comprising:
a pump resonator comprising a pumping beam, a pump gain medium, an outer mirror, and an output mirror;
a Raman resonator partially co-located with the pump resonator, the Raman resonator comprising a seed signal, a Raman gain medium, and an inner mirror,
wherein the pump resonator and the Raman resonator share the output mirror.

7. The device for amplifying Raman-shifted light of claim 6, wherein the outer mirror and the output mirror are reflective of the pumping beam, wherein the inner mirror is transmissive of the pumping beam and reflective of one or more Raman-shifted signals, and wherein the output mirror is reflective of the one or more Raman-shifted signals, and is one of the following: partially transmissive of an output signal, or selectively transmissive of the output signal.

8. The device for amplifying Raman-shifted light of claim 6, further comprising a plurality of seed signals.

9. The device for amplifying Raman-shifted light of claim 6, wherein the pumping beam is one of the following: a continuous wave light source, a long-pulse light source, or a short-pulse light source.

10. The device for amplifying Raman-shifted light of claim 6, wherein the seed signal is one of the following: a continuous wave light source, a long-pulse light source, or a short-pulse light source.

11. The device for amplifying Raman-shifted light of claim 6, wherein the pumping beam and Raman gain medium interact to generate a first Raman-shifted signal having a longer wavelength than a wavelength of the pumping beam.

12. The device for amplifying Raman-shifted light of claim 11, wherein the seed signal is tuned to a frequency of the first Raman-shifted signal.

13. The device for amplifying Raman-shifted light of claim 11, wherein the first Raman-shifted signal interacts with the Raman gain medium and the pumping beam to generate the one or more Raman-shifted signals.

14. The device for amplifying Raman-shifted light of claim 6, wherein the pumping beam passes through the pump gain medium and the Raman gain medium in at least two directions.

15. A method of amplifying light, comprising:
generating a pumping beam;
directing the pumping beam though a pump resonator containing a pump gain medium, and a Raman resonator containing a Raman gain medium, wherein the Raman resonator partially overlaps the pump resonator, and wherein the Raman gain medium is configured to interact with the pumping beam to generate one or more Raman-shifted signals;
generating a seed signal tuned to a frequency of a first Raman-shifted signal, wherein the first Raman-shifted signal is one of the one or more Raman-shifted signals;
directing the seed signal into the Raman gain medium;
containing the one or more Raman-shifted signals within the Raman resonator, wherein the one or more Raman-shifted signals circulate through the Raman gain medium, and wherein the one or more Raman-shifted signals is amplified; and
transmitting an output signal, wherein the output signal is one of the one or more Raman-shifted signals.

16. The method of amplifying light of claim 15, further comprising: generating a plurality of seed signals, and directing the plurality of seed signals into the Raman gain medium, wherein each of the plurality of seed signals is tuned to a frequency of one of the one or more Raman-shifted signals.

17. The method of amplifying light of claim 15, wherein a pumping beam profile is one of the following: a continuous wave pump, a long-pulse pump, or a short-pulse pump.

18. The method of amplifying light of claim 15, wherein a seed signal profile is one of the following: a continuous wave seed, a long-pulse seed, or a short-pulse seed.

19. The method of amplifying light of claim 17, wherein the pumping beam profile is selected based on a wavelength of the output signal.

20. The method of amplifying light of claim 17, wherein the pumping beam profile is selected based on a temporal profile of the seed signal.

21. The method of amplifying light of claim 18, wherein the seed signal profile is selected to correspond to a temporal profile of the output signal.
